(19) United States
(12) Patent Application Publication
(10) Pub. No.: US 2019/0051328 A1
(43) Pub. Date: Feb. 14, 2019

(54) METHOD AND APPARATUS FOR TRACKING PIRATED MEDIA

(71) Applicant: Marc Brandon, Sierra Madre, CA (US)

(72) Inventor: Marc Brandon, Sierra Madre, CA (US)

(21) Appl. No.: 16/165,407

(22) Filed: Oct. 19, 2018

Related U.S. Application Data
(63) Continuation of application No. 11/422,378, filed on Jun. 6, 2006.
(60) Provisional application No. 60/688,250, filed on Jun. 7, 2005.

(51) Int. Cl. G11B 20/00; G06F 21/10; G10L 19/018

(52) U.S. Cl. CPC G11B 20/00086; G10L 19/018; G06F 21/10; G11B 20/00826

(57) ABSTRACT

Pirated copies of various types of media are analyzed to detect various artifacts that may be missing from the originals. These artifacts are then used to identify and trace pirated copies for forensic studies. The artifacts may include global artifacts that are present throughout media, or could be local or special artifacts that are present only in a small portion of the media. Moreover the artifacts can be at least one of an audio event, a visual event, a visual watermark or an audio watermark.

### RELATED APPLICATIONS

This application is a continuation of U.S. patent application Ser. No. 11/422,378 filed Jun. 6, 2006 which claims benefit of U.S. Provisional Patent Application No. 60/688,250 filed Jun. 7, 2005.

### BACKGROUND OF THE INVENTION

### A. FIELD OF THE INVENTION

This invention relates to the field of tracking of pirated media. More specifically, the invention involves a method and apparatus for identifying various copies of a pirated media so that their source can be determined, and the distribution routes of various generations of these copies can be traced.

### B. DESCRIPTION OF THE PRIOR ART

Media piracy is the source of a substantial loss of revenue for content creators in the entertainment field. The Motion Picture Association of America (MPAA) estimates that losses due to piracy worldwide for the U.S. motion picture industry may exceed $6 billion on an annual basis. In order to combat the problem of media piracy, it is useful to identify each authorized copy of the media in such a way that any unauthorized copy could be traced back to the authorized copy from which it was made.

A method for marking film prints to facilitate forensic identification was developed by the Motion Picture Association of America and Kodak employees approximately 15 years ago. This technique is known as “Capcoding.” It involves placing visible dots into a spatial matrix on a film frame. Various combinations of the dots arranged in a matrix provided approximately 1000 unique codes. The dot matrix is printed onto an authorized copy. Authorized copies are then provided to each separate theater, with each copy being identified by a different code.

Other identifying techniques include invisible watermarking, which is typically used on non-theatrical content such as DVD masters, and audio watermarking. These techniques are used to detect or develop “parent-child” relationships between various pirated copies.

Another identifying technique is disclosed in the above-named patent application. In this technique, a plurality of masters are made, each master having a plurality of segments. A code is assigned to each master, and this code is associated with each segment. Many authorized copies are made by combining segments from different masters. Each authorized copy consists of a plurality of segments, with at least some of the segments having different codes then other segments of the same copy. The segments are selected so that each authorized copy consists of a unique combination of segments, thereby uniquely identifying the copy.

A problem with both approaches is that once the authorized (first generation) copy is made then any second generation copies made from the first copy all have the same identifiers and therefore they cannot be traced. For example, if an authorized copy is shown in a movie theater and used to make several pirated (second generation) copies, then the second generation copies will have the same identifier as the first generation copy. Any forensic analysis performed on these second generation copies or any subsequent third generation copies will only reveal the theater from which the second generation copies originated.

### BRIEF DESCRIPTION OF THE DRAWINGS

FIG. 1 shows a flow chart of a method of tracking pirated media in accordance with the present invention;

FIG. 2 shows somewhat diagrammatically a plan view of a movie theatre wherein a feature presentation is pirated using camcorders;

FIG. 3 shows timing diagrams for a feature presentation and two pirated copies;

FIG. 4A shows a sequence of scenes and the corresponding marks identifying the location of the scenes on the original and a pirated copy;

FIG. 4B shows a listing of artifacts that may be found in the pirated copy;

FIG. 5 shows a block diagram of an apparatus used to identify and track pirated media:

FIG. 6A shows a diagram of the peak volume of an authorized copy and two pirated copies as a function of time;

FIG. 6B shows the average luminescence of an authorized copy and two pirated copies as a function of time;

FIG. 7A shows a block diagram of a comparator circuit for comparing peak volumes; and

FIG. 78 shows a block diagram of a comparator circuit for comparing average luminescence.

### DETAILED DESCRIPTION OF THE INVENTION

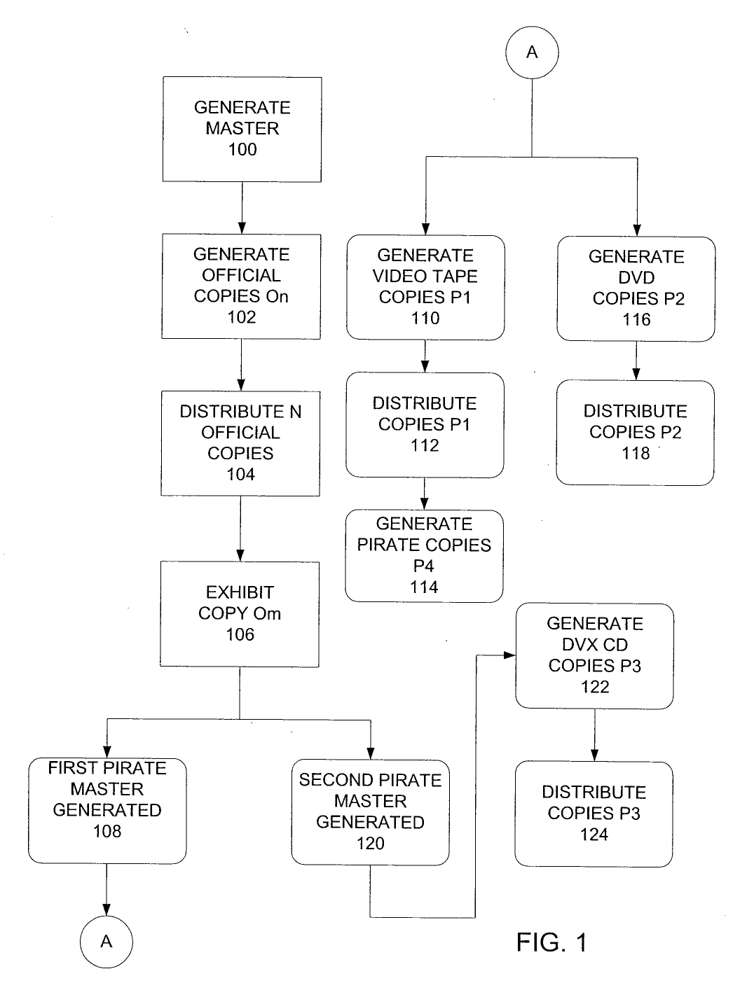

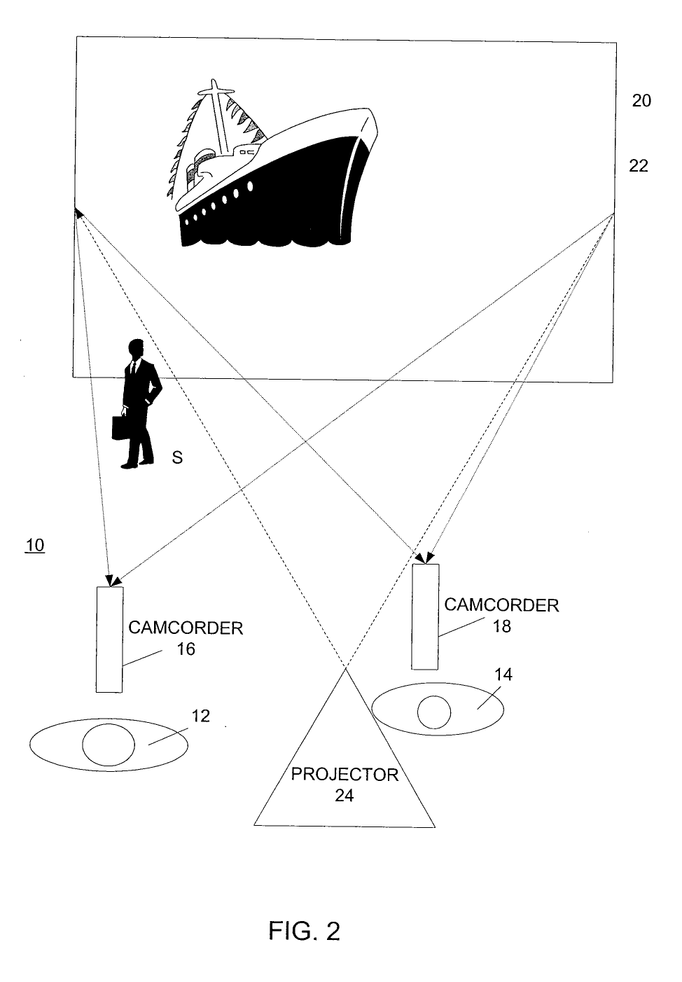

Media are pirated in many different ways. For example, an illegal copy can be made in a movie theatre using a camcorder, as illustrated in FIGS. 1 and 2. In step 100 a master is generated by a content provider such as a movie studio. In step 102 several (first generation) authorized or official copies 01, 02 . . . On are generated. These authorized copies include unique identifiers, such as the ones described above.

In step 104 an authorized copy Om is played in a specific theater. While the copy Om is played, two pirates record it using respective hand held cameras 16, 18. More specifically as shown in FIG. 2, the copy Om 22 is played by projector 24 on screen 20. As can be seen in the FIG. 2, the two pirates 12, 14 are recording the movie 22 through two respective camcorders 16 and 18. The two pirates can be filming copy Om simultaneously, or at different times, and they can be cooperating or can be operating independently of each other. The two pirates thus produce, respectively, a first and a second pirated master PM1 and PM2. Frequently, the audio track for the masters is not recorded by the camcorders. Instead, a different audio source is used to record the audio track and this audio track is then synced with the video track. For example, in many instances, the audio portion of a movie is made available on devices having an audio output for people having a hearing impairment. An audio recorder is plugged directly into such a device and used to generate the separate audio track.

The two pirated masters are not identical. One difference is that they are being shot from different angles causing slightly different distortions. Another difference stems from the fact as the authorized copy Om is being presented, various events take place that cause certain extraneous aural or visual artifacts in the pirated masters. (The term “artifact” is used herein to designate any feature of a pirated copy that is not found in the original). For example, at one point during the film, a spectator S may stand up and walk out. When that happens, he temporarily blocks off the field of view of pirate 12 but not necessarily that of pirate 14. Alternatively, if the pirates 12, 14 are close enough, the spectator S could block the field of view of both pirates at least partially, but the amount of occlusion is different. In either case, during the time that the fields of view of the camcorders are blocked portions of the recorded images are darker than the images on the authorized copy Om. Other events may cause the copied images to be lighter, for example, if the film rips causing a complete white screen, or if a door is inadvertently opens throwing light onto the screen.

Many other events may cause artifacts on the pirated masters. For example, coughs or laughter by spectators are superimposed on the recorded sound tracks of the pirated masters and increase their average or peak sound levels. The peak or average sound levels could be also decreased, for example, by a rip in the film, or temporary malfunction of the camcorder (assuming that the audio track of the pirated master is obtained from the camcorder and not a separate source, as discussed above). A common practice of pirates is the taking an audio track from one source and syncing to a separate video source. This is most common for foreign language pirate samples, but happens with English video to English audio as well. The generation of pirated masters can be thus developed by monitoring sound artifacts in pirated copies.

Back to FIG. 1, pirate 12 generates a pirated master PM1 (step 108). He, or others, then generates from the pirated master PM1 a plurality of pirated copies P1 on VHS tapes. In step 112 these copies P1 are distributed by various means.

In addition, the pirated master PM1 may be used to generate a plurality of DVD copies P2 in step 114. Copies P2 are then distributed in step 116 either in the same markets as P1 or different markets.

Similarly, pirate 14 makes the second pirated master PM2 in step 118. In step 120 this second pirated master is used to make other pirated copies P3 in any suitable media, such as VCR tapes, DVD discs or DIVX CD copies. In step 122 the pirated copies P3 are distributed, again, either in the same market as P1, P2, or in different markets. For example, the DVD copies P2 could be sold on streets in USA while the CD versions of pirated copy P3 maybe distributed in Asia where DVIX CDs are more popular.

Of course, the chain need not stop here. Some of the copies may be used as pirated masters to make yet other copies. For example, one of the copies P1 can be used as a pirated master PM3 to make copies P4 (step 114).

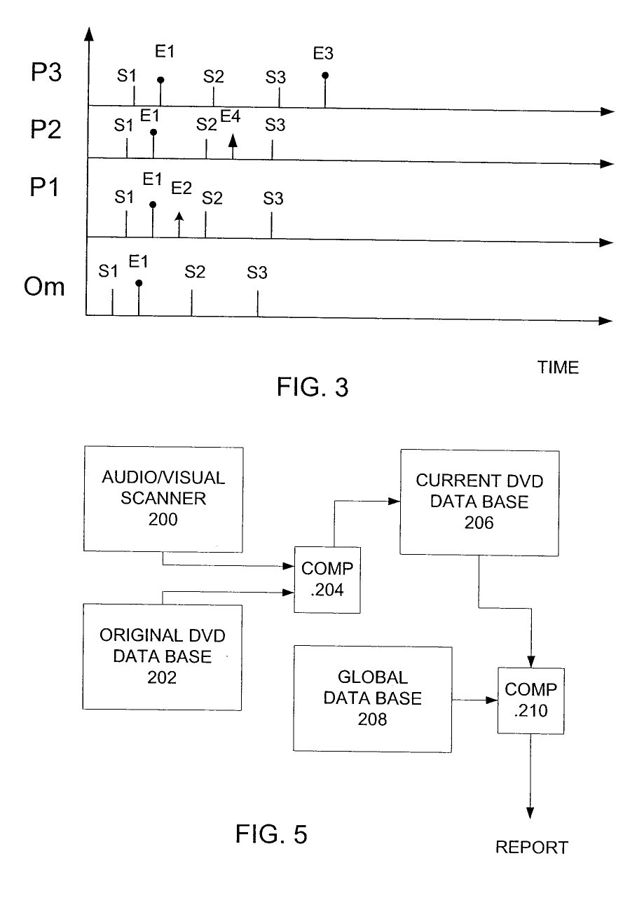

The sets of pirated copies P1, P2, P3, P4 all originate from authorized copy Om but are different from each other because they include different artifacts. Artifacts can be generated by individual events (some of which are discussed above) as well as other phenomenon that are associated with the equipment used to make the pirated copies and may be characteristic of an entire copy, rather then one or more scenes. For example, as shown in FIG. 3, while all the copies contain the same scenes S1, S2, S3, because of some of the unique characteristics of steps 108, 110, 114, 118, 120 there may be a slight variation in their duration. Moreover, during these same processes, various artifacts may be introduced that may but need not be the same. For example, artifact F1 maybe a set of dark or blurred images generated by dirt on the lens of projector 24. Artifact E2 may be a set of partially occluded frames caused by spectator S standing up. Artifact E3 maybe a cough by a spectator near enough to pirate 14 so that it is recorded by his camcorder 18 but not camcorder 16. Artifact E4 maybe a set of images blurred by the process of step 114.

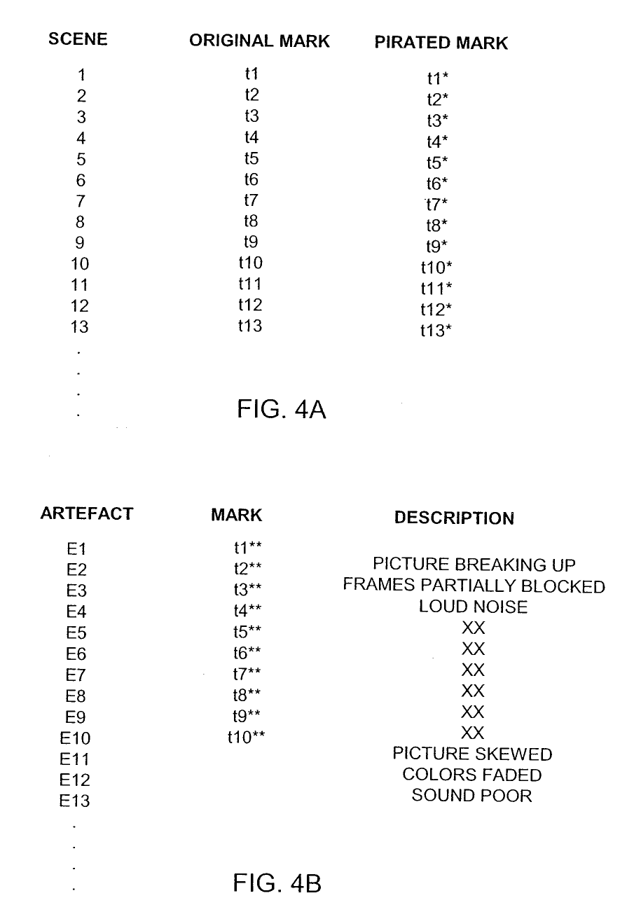

In summary, pirated copies include several artifacts. Some of these artifacts are global artifacts in the sense that they are applicable to an entire pirated copy, while other artifacts may be specific artifacts that pertain to a single frame or a small group of frames. In the present invention, parameters associated with each artifact are recorded and used as means of uniquely identifying the pirated copies. For example, FIG. 4A shows a table in which the starting position of each scene from each tape is cataloged and stored. On the authorized copy Om scene 1 starts at mark t1, scene 2 starts at t2 and so on. Because of delays in starting the respective camcorder and delays internal to the apparatus used to make the copies, the scenes on the various copies, start at different marks t1*, t2*, t3*, etc. The marks t1, t2, t1*, t2*, etc., may be timing marks, frame numbers, or other similar indicia. Thus, one general or global artifact that can be used as an identifier of pirated copies consists of a listing of marks t1, t2. Other artifact parameters may include the duration, of each scene, the number of frames in each scene, total or average luminescence, peak or average sound levels of each scene and/or the whole program, and so on.

Other general or global parameters may be used as well. For example, if camcorders 16, 18, are not positioned in the center, the images recorded by these devices are slightly skewed or distorted. These distortions can be measured and used as identifying artifacts. Alternatively, because of differences in processing, some of the colors of the images may be changed when compared to the original master or authorized copy. For example, an object (such as a hat) may have a bright red color in the original and a faded orange hue throughout the copy. Again this feature can be sensed and used as an identifier or a global artifact parameter.

FIG. 4B shows a list of the various specific artifacts found in pirated copies (in this instance, P1). Optionally, additional information may be incorporated in the list. Some of the additional information and description may be provided for each artifact. For example, E1 may be an instance where the picture breaks up, E2 indicates that several frames are partially blocked (for example by man S walking out), E3 may be a loud noise. In the examples given above, artifacts E1-E13 occur at specific times and have limited durations (generally in the order of a couple of frames).

FIG. 5 shows a block diagram of an apparatus for collecting and correlating artifacts from various pirated copies. The apparatus includes an audio/visual scanner 200 that scans a pirated copy, e.g., P1. During this scanning process, the various preselected characteristics of the pirated copies (such as the lists of FIGS. 4A and 48) are collected. These characteristics are then compared by comparator 204 with the parameters and characteristics of an original master. For this phase of the process, an original data base 202 is provided. The data in this data base is obtained by scanning one of the copies or from the content provider. The comparator 204 then identifies the characteristics of the pirated copy that differ from the characteristics in the data base 202. The information is stored in the current data base 206 as a first set of parameters AS1 that identify the respective pirated copy, e.g., P1. Pirated copy P2 may be associated with a second AS2 that may be slightly different then AS1. The parameters of a set AS4 for pirated copy P4 may include the parameters AS2 and may have some additional parameters associated with process 124.

As discussed above, the parameters are an effective means of providing a unique identification of the respective copy. These parameters may include video-only artifacts, audio-only artifacts or combinations of video and audio artifacts. Using this identification, one can track or trace the source of various pirated copies as follows.

The parameters AS1, AS2, AS3, AS4 of various known pirated copies P1, P2, P3, P4 . . . are collected and stored in a global data base 208 so that in effect the data base 208 includes a veritable parameter library descriptive of the various pirated copies. This parameter library is generated and kept locally by each organization monitoring copying of various media. Alternatively, the parameter library can be distributed and shared between various monitoring organizations. Moreover, parameter libraries from different organizations can be compared and combined to make a more complete and comprehensive parameter library.

Any pirated copy received by any of these organizations can then check it using the device shown in FIG. 5 as well. First, the pirated copy us scanned by scanner 200 and compared to the characteristics of the original by comparator 204. The resulting set of parameters AS* is stored in data base 206.

Next, the set AS* is compared to the sets AS1, AS2, AS3 . . . in data base 208 and a report is then generated to indicate whether the set AS* (a) match the parameters of any known pirated copies; or (b) include the parameters of a known pirated copy (e.g., AS2) but include additional parameters; or (c) do not match of the parameters of any pirated copies and therefore this is a new pirated copy. Moreover, as discussed previously, the authorized copy Om preferably is encoded so as to uniquely identify the theater 10. This information is provided in the report as well and used to identify the theater (or other venue) from which pirated copies originate. This whole process is preferably performed automatically using computer-based equipment.

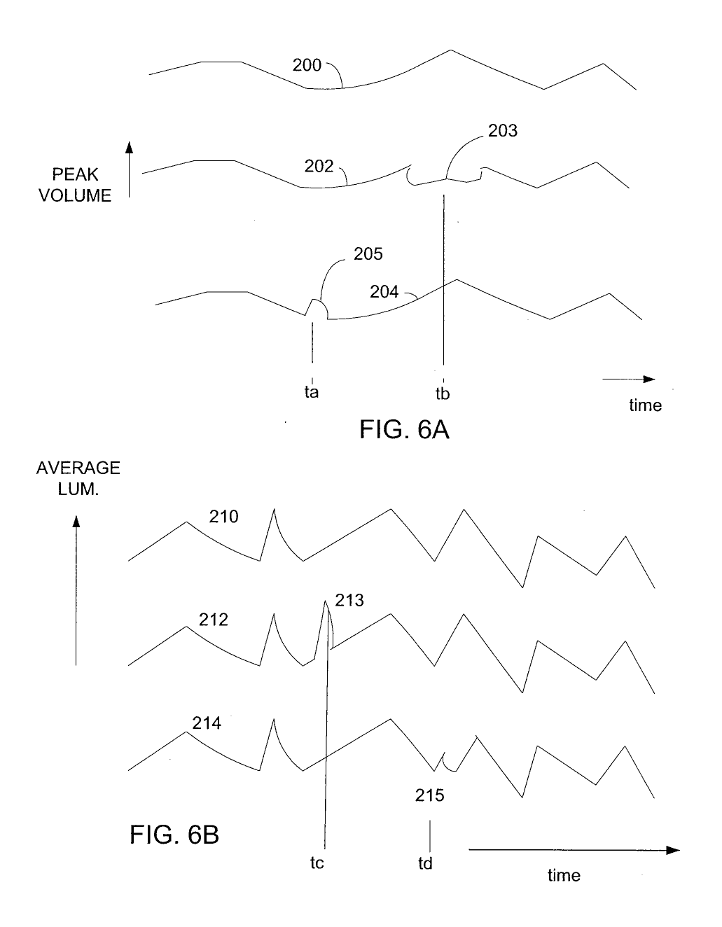

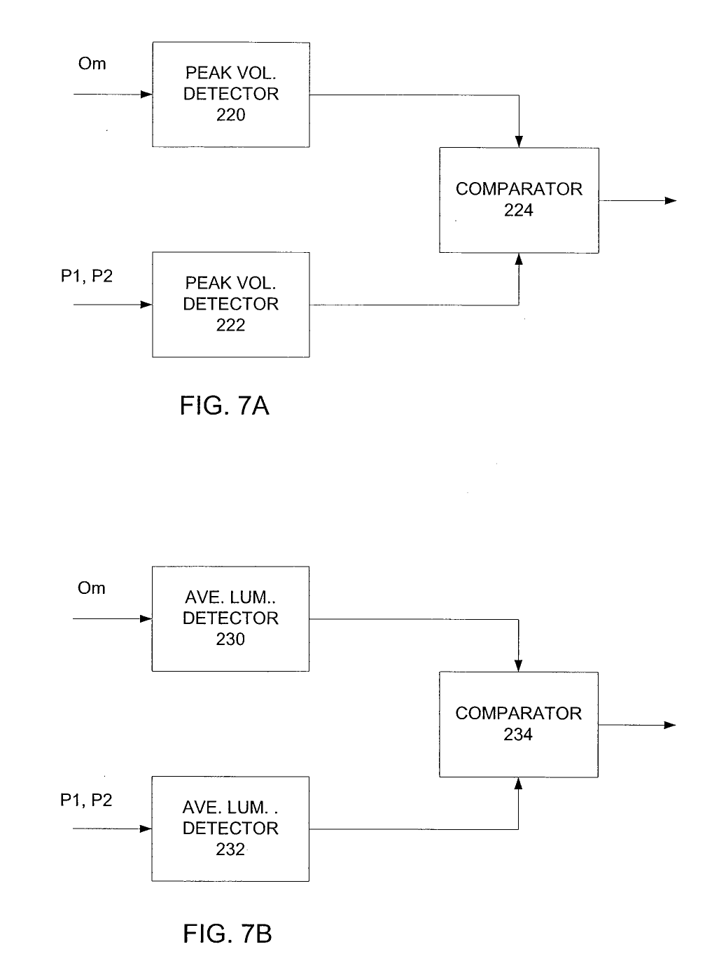

FIGS. 6A and 6B show some typical characteristics that may be used to identify the parameters. FIG. 6A shows portions of typical peak volume waveforms. Waveform 200 is from the authorized copy, waveform 202 is from one of the pirated copies, e.g., P1 and waveform 204 is from another pirated copy, such as P3. As can be seen in the Figure, at t=ta an artifact 205 occurs on waveform 204. This artifact may be caused by coughing, loud laughter, etc. Waveform 200 does not have this artifact. Therefore this artifact (including its position, duration, and/or amplitude) may also be one of the parameters of set AS3 for pirated copy P3. At t=tb an artifact 203 occurs on waveform 202. This artifact (a lowering of the peak volume) may be due to a ripped film, a dropout from the camcorder, the pirate covering the microphone with his hand, and so on. The characteristics of this artifact may be used as a parameter for set AS1. As shown in FIG. 7A, in order to detect artifacts 203, 205, the authorized copy Om is scanned by a peak volume detector 220 and the pirated copies P1, P3 are scanned by a peak volume detector 222. Alternatively, the peak volume of Om can be obtained from other sources (e.g., the content provider) and stored in data base 102). The peak volumes of P1, P3 are compared by comparator 224 and the characteristics of artifacts 203, 205 are forwarded to data base 106. The peak volume may be detected for each frame, for several frames, etc. Moreover, instead of the peak volume, other characteristics may be used, such as average volume, and other characteristics.

FIG. 6B shows three curves for the average luminescence curves 210, 212, 214 of Om, P1, P3, respectively. In this case, an artifact 213 appears at tc on curve 212, caused by an event that increases the average luminance of the frame at t=tc. Another artifact 215 appears at t=td caused by an event that reduces the average frame luminance as discussed above. These artifacts are detected by the circuitry of FIG. 78. Average luminance detectors 230 and 232 detect the characteristics of Om, P1 and P3. The results are compared by comparator 234 and sent to the current data base 206. Of course these artifacts may be detected using the average or peak luminance of a single frame or several frames, and other similar means.

in the embodiments described above, and in FIGS. 1-7B, pirated copies originate from masters made by handheld camcorder. Of course the present invention is useful to identify and track pirated media made by various other means as well.

As described above, pirated copies of content are analyzed in accordance with this invention and generations of copies are identified using sets parameters, each set being formed of one or several artifacts. The artifacts include visual artifacts, audio artifacts and other indicia such as invisible watermarks, inaudible watermarks and combinations thereof.

Numerous modifications may be made to the invention without departing from its scope as defined in the appended claims.

1. A method of processing a pirated audio visual programs which are unauthorized versions of an authorized master audio visual program, the authorized master comprising electronically stored content including an audio component and a video component and being playable as an audio visual program by a content player, the method comprising the steps of:
scanning the authorized master using a media scanner for preselected characteristic properties reflecting at least one of a video property and an audio property of the authorized master to generate a master set of characteristics;
receiving first pirated media comprising electronically stored content including an audio component and a video component and playable as an audio visual program by a content player;
scanning the first pirated media using the media scanner for the preselected characteristic properties to generate a first set of pirate media characteristics;
comparing with a comparator the first set of pirate media characteristics with the master set of characteristics to identify at least one introduced artifact in the first pirated media absent from the authorized master, the introduced artifact in the first pirated media comprising at least one of an audio and a visual deviation of the first pirate media content from the master media content;
storing in a database a first set of pirate parameters corresponding to the first pirated media, the first set of parameters indicating the at least one introduced artifact associated with the first pirated media copy and absent from the master audio visual program;
receiving second pirated media comprising electronically stored content including an audio component and a video component and playable as an audio visual program by a content player;
scanning the second pirated media using the media scanner for the preselected characteristic properties to generate a second set of pirate media characteristics;
comparing with a comparator the second set of pirate media characteristics with the master set of characteristics to identify at least one introduced artifact in the second pirated media absent from the authorized master, the introduced artifact in the second pirated media comprising at least one of an audio and a visual deviation of the second pirate media content from the master media content;
generating a second set of pirate parameters indicating the at least one introduced artifact associated with the second pirated media copy;
comparing the second set of parameters to the first set of pirate parameters previously stored in the database and then :
(a) determining if the second set of pirate parameters is the same as the first set of pirate parameters and in response indicating that the second pirated media copy is a duplicate of the known first pirated media copy;
(b) determining if the second set of pirate parameters contains the first set of pirate parameters and additional parameters and in response (i) indicating that the second pirated media has been derived from the first known first pirated media copy, and (ii) storing in the database the second set of pirate parameters corresponding to the second pirated media copy; and
(c) otherwise (i) indicating that the second pirated media is a new pirated copy and (ii) storing in the database the second set of pirate parameters corresponding to the second pirated media copy.

2. The method of claim 1, wherein the preselected characteristic properties comprise recorded audio volume, the scanner comprises a volume detector and introduced artifacts comprise variation in volume of an audio portion of the audio visual program of a respective pirated media copy relative to volume of a corresponding video portion of the master audio visual program.

3. The method of claim 2, wherein the variation in volume comprises a variation in peak volume.

4. The method of claim 2, wherein the variation in volume comprises a variation in average volume.

5. The method of claim 1, wherein the preselected characteristic properties comprise video luminance, the scanner comprises a luminance detector and introduced artifacts comprise variation in luminance of frames of a video portion of the audio visual program of a respective pirated media copy relative to luminance of frames of a corresponding portion of the master audio visual program.

6. The method of claim 5, wherein the variation in luminance comprises a variation in peak luminance.

7. The method of claim 5, wherein the variation in luminance comprises a variation in average luminance.

8. The method of claim 1 wherein the introduced artifact in the first pirated media comprises a global difference between at least one of the audio and the visual characteristics of the master audio visual program on said authorized master relative to audio and visual characteristics of the first pirated media, the global difference being present substantially throughout said first pirated media.

9. The method of claim 1 wherein said first pirated media has at least one program segment having a duration, the introduced artifact in the first pirated media comprises a difference in duration of the program segment relative to a duration of a corresponding segment in the master media.

10. The method of claim 1 wherein the introduced artifact in the first pirated media is at least one of an audio event, a video event, a visual watermark and an audio watermark.

11. The method of claim 1 wherein the introduced artifact in the first pirated media comprises a visual artifact.

12. The method of claim 1 wherein the preselected characteristic comprises a plurality of events arranged in a time dependent sequence, the step of scanning the first pirated media comprising determining time intervals between said events.
